(19) United States
(12) Patent Application Publication
(10) Pub. No.: US 2016/0153714 A1
(43) Pub. Date: Jun. 2, 2016

(54) METHOD FOR OPERATING AN ELECTRIC ARC FURNACE AND ELECTRIC ARC FURNACE

(71) Applicant: Primetals Technologies Austria GmbH, Linz (AT)

(72) Inventors: Markus DORNDORF, Baden-Baden (DE); Ralf ENGELS, Heroldsbach (DE); Michel HEIN, Brumath (FR); Klaus KRÜGER, Sealdorf-Surheim (DE); Domenico NARDACCHIONE, Offenburg (DE)

(21) Appl. No.: 14/902,722

(22) PCT Filed: Jun. 24, 2014
(86) PCT No.: PCT/EP2014/063283

§ 371 Date: Jan. 4, 2016

(30) Foreign Application Priority Data
Jul. 4, 2013 (EP) 13175076.2

(51) Int. Cl. F27B 3/08; F27B 3/28; F27D 27/00; H05B 7/20

(52) U.S. Cl. CPC F27B 3/085; H05B 7/20; F27B 3/28; F27D 27/00

(57) ABSTRACT

An electric arc furnace (2) and to a method for operating an electric arc furnace having at least one electrode (4a, 4b, 4c) for generating an electric arc (6a, 6b, 6c), in which the desired value of the current (I) guided to the electrode (4a, 4b, 4c) oscillates about a predetermined base value (I₀).

### CROSS-REFERENCE TO RELATED APPLICATIONS

The present application is a 35 U.S.C. §§371 national phase conversion of PCT/EP2014/063283, filed Jun. 24, 2014, which claims priority of European Patent Application No. 13175076.2, filed Jul. 4, 2013, the contents of which are incorporated by reference herein. The PCT International Application was published in the German language.

### TECHNICAL FIELD

The invention relates to a method for operating an electric arc furnace and an electric arc furnace.

### TECHNICAL BACKGROUND

An electric arc furnace is a unit for melting and recycling steel scrap. In accordance with the manifold areas of use of steel, a wide range of scrap is used in an electric arc furnace of this type. The scrap can be fed into the electric arc furnace in the form of swarf and thin wires through heavy beams or even bars weighing several tons.

In conventional electric arc furnaces, at the beginning of the smelting process, the scrap is fed as loose material into the electric arc furnace. This loose material can be melted very efficiently since the loose material surrounds the electric arcs and so absorbs the radiant energy.

In the melting phase, smelting of the scrap over a wide volume is desired. Thus as soon as the surroundings of the electrodes has been melted free, the risk of turbulent scrap collapses increases, wherein scrap slips in the direction toward the electrodes and can cause an electrode breakage. For this reason, modern electric arc furnaces are operated during the melting phase with a secondary voltage which is as high as possible (nowadays typically up to 1200 V), by which means long electric arcs form and melting of the scrap over a wide area is achieved in the region of influence of the long arc. Shortening of the melt duration is achieved and the risk of electrode fractures is decreased.

In older electric arc furnaces, their furnace transformers tend to have small voltage steps compared with modern systems (typical secondary voltage for older systems: max. 800 V), so melting of scrap over a broad region is not realizable in the conventional manner.

Following melting down of parts of the scrap, a liquid bath of molten steel exists typically containing numerous larger pieces of scrap which still have to be melted. These are no longer reached directly by the arc/arcs. They can then only be melted by means of convection from the adjacent liquid bath. Since the temperature of the molten bath lies only slightly above the liquidus temperature and the bath movement is slight, this melting requires a relatively long time.

Particularly in the case of very large scrap pieces, the required processing time increases so that the efficiency of the melting process falls. The risk exists that individual scrap pieces have still not completely melted on tapping and in the worst case, they block the tapping opening.

Apart from conventional electric arc furnaces with charging by the basket, the phenomenon described also concerns electric arc furnaces in which the charging takes place by means of a shaft, or continuously. The effect may even be amplified since all of the input material is introduced into a limited sector of the furnace vessel. This sector is a pre-determined cold site.

### SUMMARY OF THE INVENTION

It is therefore an object of the present invention to provide a method for operating an electric arc furnace, and an electric arc furnace in which these disadvantages are avoided and the melting process of the steel to be melted is improved.

According to the invention, the first object is achieved by a method for operating an electric arc furnace having the features disclosed herein. According to this, on operation of an electric arc furnace having at least one electrode for generating an electric arc, oscillation of the target value of the current fed to the electrode about a pre-determined base value takes place.

Within the meaning of the invention, an “oscillation” is here means both a change in the target value of the current fed to the electrode departing from the pre-determined base value and then back again to the base value, as well as a periodic change of the target value of the current fed to the electrode about the pre-determined base value.

An oscillation or adjustment of this type in the target value of the current fed to the electrode enables influencing the electric arc length at the electrode. Targeted lengthening of the electric arc at an electrode and simultaneous shortening of the electric arc at the further electrodes that are possibly also present leads during melting operation, with suitable alternating control, to increased all-round radiation output. In older systems, in particular, melting of the scrap over such a wide volume can be achieved despite the low existing secondary voltage of the furnace transformer.

By this means, shortening of the melting times and reduction in the risk of scrap collapses is achieved. As soon as a molten bath has been formed, by means of an electric arc furnace operated in this way, suitable bath movement can also be generated which significantly improves the convective heat transfer so that a homogeneous and rapid melting of the scrap is achieved.

The method according to the invention is therefore advantageous over the entire melting process, beginning with the presence of scrap in the furnace, through the presence of a molten bath and scrap, as far as the complete dissolving of the scrap in the molten bath.

It has proven to be successful for the method if the oscillation takes place periodically. With a plurality of electrodes, wandering of the elongated arc from one electrode to the next can be achieved. In particular, the periodic frequency f in the scrap melting phase is from 0.05 Hz to 0.2 Hz.

A prolonged dwell time with elongated electric arcs in regions of the furnace with particularly large scrap parts is possible, wherein the remaining regions are passed through quicker with smaller more rapidly meltable scrap parts. By this means, evening out in the temperature profile of the furnace and thus a more even and more rapid melting can be achieved. The dwell time in a particular region of the furnace space is dependent, in particular, on the number of short circuits counted since the beginning of the melting phase and/or the mean radiation distribution of the molten bath already reached and/or the current thermal wall loading of the cooling elements.

Particularly preferably, the electric arc furnace comprises three electrodes and the respective currents have a phase shift of 120°.

Due to the oscillation of the target value of the current I one after another at each of the three electrodes, a longer electric arc is specifically generated at the respective electrode affected by the oscillation and, at the unaffected electrodes, an electric arc that is shorter relative thereto is generated. This takes place particularly by means of an impedance adjustment at the (usually symmetrical) impedance target operating points of the electrode regulation. By this means, a neutral point of the 3-conductor secondary voltage system is displaced so that a particular phase experiences a voltage increase of up to 1.5 times at the expense of the voltage level of another phase voltage.

In order to describe the effect mathematically, the “radiative index” RE of an electrode will now be introduced.

RE=U_{arc}*P_{arc}
where U_{arc}=voltage at the electrode
and P_{arc}=power output of the electrode

By means of the radiative index, the electric arc length and the melting effect thereof can be represented with a simplified model. Herein, an increase in the radiative index corresponds, expressed in a simplified way, to an arc elongation. The necessary impedance adjustment to increase the radiative index at an electrode is dependent on the phase-sequence. Herein, the impedance target values can be adjusted so that the increase in the radiative index at an electrode is achieved by a symmetrical, that is, in each case the same, reduction at the other electrodes.

An example of a symmetrical radiation increase is therefore:
RE (Electrode 1)=120%
RE (Electrode 2)=90%
RE (Electrode 3)=90%

Herein, the electric arc at electrode 1 would be elongated and the arcs at the electrodes 2 and 3 would be shortened, specifically by the same amount.

A radiative index adjustment of this type is restricted in the initial melting phase to a maximum of 20%. Measurements have shown that an impedance adjustment of 15% brings about an approximately 20% radiation increase at the electrode with the elongated arc. Adjustments going beyond this have the effect of reducing the overall power output in the furnace. The stipulation of a level of the radiation dynamic can be meaningfully made with a radiative index pre-set value in the respective step of a furnace operation program and/or depending on a current transformer tap and/or a current curve number and/or an evaluation of the harmonics. A “curve number” should be understood to be a particular operating point of a transformer tap, wherein different operating points can be set for a transformer tap. A fixed association of particular curve numbers of a transformer tap to an operation program can take place wherein a radiative index adjustment is carried out or no radiative index adjustment is carried out.

In particular, the three electrodes are arranged, seen in the direction of their longitudinal axes, on a circular line and the longer electric arc in the electric arc furnace circulates recurrently round a region enclosed by the circular line. This can be achieved by means of cyclical exchange of the adjustment pattern in the three phases, wherein each electrode passes through a radiation increase one after the other. A long electric arc is formed which wanders from electrode to electrode and so effectively circulates round the electrode group.

Preferably, therefore, scrap is present in the electric arc furnace and, by means of the oscillation of the target value of the current I, an increase of a radiation output power generated by the arc is achieved in a targeted manner.

Furthermore, a molten bath is preferably present in the electric arc furnace and by means of the oscillation of the target value of the current I, a movement of the molten bath in the electric arc furnace is created in a targeted manner. Herein, in particular, a movement of the molten bath circulating round the at least one electrode—seen in the direction of its longitudinal axis—is created in a targeted manner. This stirring movement significantly promotes the melting process.

This is based on the following findings:

The electric arc generated by the electrode of the electric arc furnace represents a plasma jet which has an impulse. This impulse acts on the liquid steel bath, so that an impression on the bath is brought about and thus a bath movement is caused. The force action F increases over-proportionately with the effective value of the arc current, that is with the current I fed to the electrode. Herein, the force is proportional to I².

Through an oscillation of the target value of the current I fed to the electrode about a pre-determined base value and thus specifically also the effective value of the arc current, the bath surface is made to perform oscillations. By means of these oscillations, a suitable bath movement can be generated, by means of which the convective heat transfer is improved. A suitable bath movement can preferably be generated in that the oscillation takes place periodically, particularly with a periodic frequency of between 0.2 Hz and 2 Hz.

A further improvement of the convective heat transfer takes place in a three-phase electric arc furnace which comprises three electrodes and electric arcs arranged in a triangle, in addition to the selection of a suitable periodic frequency, by means also of a suitable phase position of the respective currents fed to the electrodes.

On operation of a conventional three-phase electric arc furnace, with a liquid bath, the electric arcs burn very stably on the bath surface. In this operating mode, hardly any variations of the effective values of the currents fed to the electrodes occur. Caused by the 100 Hz (double mains frequency) rotation of the arcs, a slight bath movement can be stimulated. This effect evoked by the phase shift of the individual currents can now be additionally used by the operation according to the invention of an electric arc furnace for the generation of a bath movement.

By means of the oscillation according to the invention of the target values of the currents fed to the electrodes about a pre-determined base value and through an additional phase shift of the individual currents of the respective electrodes, an enhanced rotation and resultant movement of the bath can be achieved as compared with the conventional operation of an electric arc furnace. The individual currents of the respective electrodes thus have, for example, the following form:

I=I₀+ΔI*sin(2πft+φ).

Herein, I is the effective value of the current fed to an electrode and is made up of a base value I₀ and an oscillating portion ΔI*sin(2πft+φ). φ is the phase angle wherein, in a three-phase electric arc furnace, the respective currents have a phase shift of 120°.

The oscillation of the current and the resultant movements of the steel bath about the base value can therefore take place by changing the amplitude ΔI and/or the periodic frequency f of the current. In other words, the amplitude ΔI and the periodic frequency f can also be altered during a melting process in order to create a desired bath movement. In particular, at the beginning of the melting process and a starting bath movement, the periodic frequency can be increased during a time segment. In order therefore to allow a bath movement to start, a low periodic frequency f is used at the beginning and is then raised with increasing bath movement and this, in turn, leads to a new increasing bath movement. The periodic frequency f is selected herein on the basis of the inertia or mass of the steel bath. The increase of the periodic frequency f in the time segment under consideration preferably takes place such that a bath movement is maximized. Following the time segment under consideration, the periodic frequency f can again be kept constant.

If a suitable periodic frequency f of 0.2 Hz to 2 Hz is selected for the oscillation, then a circulating wave forms in the furnace vessel. Depending on the vessel and the pitch circle diameter, suitable frequencies lie in the region below 1 Hz. The resulting defined, settable bath movement leads to the desired good convective heat transfer. The formation of the wave can be favored particularly by an increase in the periodic frequency f of the currents fed to the individual electrodes during the initial generation of the bath movement. The respective periodic frequencies f of the currents and thus the circulation frequency of the circulating wave in the steel bath is therefore increased such that the increase in the rotation speed of the steel bath, that is, the acceleration thereof is maximal.

Altogether, through the targeted oscillation of the target values and consequently the effective values of the current and a suitable circulation frequency, forced rotation of the steel bath and an associated better mixing and temperature homogenization of the steel bath is brought about. Particularly in the case of eccentrically supplied electrical energy and/or of eccentric melting material addition and an associated uneven energy input or an eccentric melting material distribution, a better distribution or supply of the energy to the melting material is brought about. Resulting therefrom are shorter processing times and the ensuring of charging times and pre-heating times in shaft furnaces.

The method according to the invention can also be used in a DC electric arc furnace. This typically has only one electrode, or in a few exceptional cases, two electrodes. By defined variation of the target value and thus the effective value of the current fed to the electrode, a wave extending outwardly from the center of the furnace vessel is achieved. By this means also, the convective heat transfer is improved.

The method described is usable both for conventional electric arc furnaces and for shaft furnaces.

According to the invention, the second object is achieved by an electric arc furnace having the features disclosed herein. An electric arc furnace of this type has at least one electrode for generating an electric arc and a control/regulating unit in which software for carrying out the method according to the invention is implemented.

The above-described properties, features and advantages of this invention and the manner in which these are achieved will now be described in greater detail more clearly and explicitly in the context of the following description of the exemplary embodiments, and by reference to the drawings.

### BRIEF DESCRIPTION OF THE DRAWINGS

For further disclosure of the invention, reference is made to the exemplary embodiments of the drawings. These are schematic principle sketches in which:

FIG. 1 is a schematic sectional view of an electric arc furnace, and

FIG. 2 is a graphical representation showing the effective value and/or target value of a current fed to an electrode over time.

### DESCRIPTION OF AN EMBODIMENT

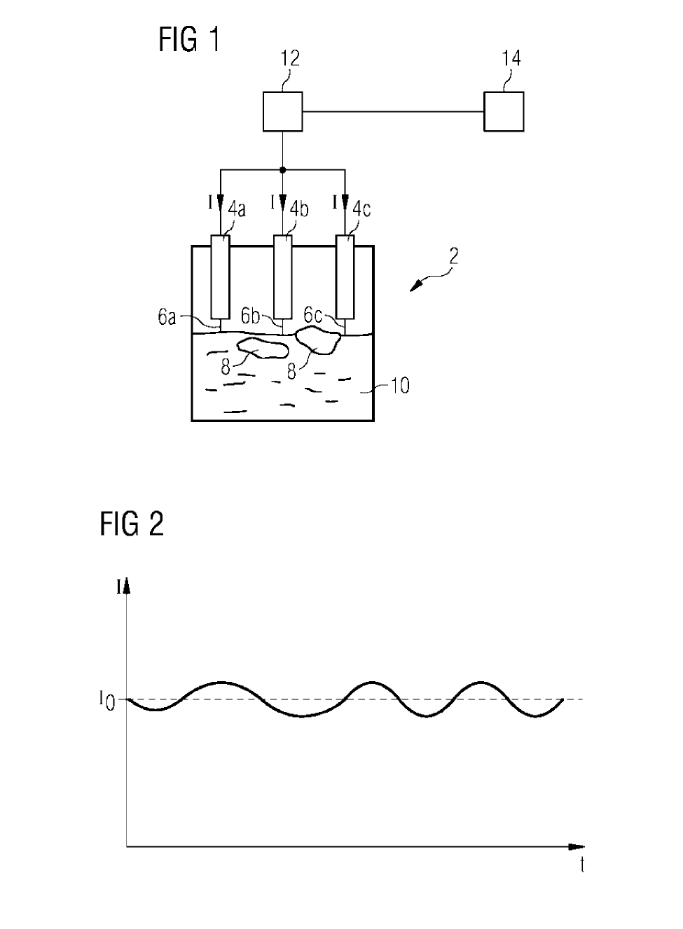

FIG. 1 shows an electric arc furnace 2 with, in this case, three electrodes 4a, 4b, 4c for generating an electric arc 6a, 6b, 6c for smelting scrap parts 8 made of steel. The three electrodes 4a, 4b, 4c are herein arranged in a triangle as viewed in the longitudinal direction of the electrodes. During the operation of the electric arc furnace 2, the scrap parts 8 are melted so that a molten bath 10 forms in a vessel of the furnace. By elongating the arcs 6a, 6b, 6c one after the other at each of the three electrodes 4a, 4b, 4c (with simultaneous shortening of the arcs at the two other electrodes), a circulating elongated arc is generated, seen in the direction of the longitudinal axes of the electrodes, so that a spatially more extensive melting of the scrap is enabled.

In the molten bath 10 shown, after a certain operating time of the electric arc furnace 2, typically, there are numerous larger scrap pieces 8 still to be melted. These are no longer reached by the arcs 6a, 6b, 6c. They can thus then only be melted by means of convection from the adjacent liquid molten bath 10. The individual electrodes 4a, 4b, 4c are each connected to a current source 12 which feeds a current I to the electrodes 4a, 4b, 4c.

In order now to ensure the further melting of the scrap pieces 8 situated in the liquid molten bath 10, the current I fed to the electrodes 4a, 4b, 4c is further adjusted by means of a control/regulating unit 14 such that an oscillation of the target value of the current I fed to the electrodes 4a, 4b, 4c about a pre-determined base value I₀ takes place. This is achieved in that initially the current target values or the impedance target values of the corresponding electrodes 4a, 4b, 4c or arcs 6a, 6b, 6c are varied.

The temporal variation of the target value of, for example, the current I fed to the electrode 4a over time t is shown in FIG. 2. As can be seen, the effective value of the current I oscillates periodically, for example, with a frequency of 1 Hz, in this case, sinusoidally about the pre-determined base value I₀. The effective value of the current therefore does not remain constant, but oscillates about the pre-determined base value I₀. Due to this type of oscillation of the current I, a movement of the molten bath 10 is induced, so that the convection is improved. A current I therefore has the following form:

I=I₀+ΔI*sin(2πft+φ).

The bath movement can be controlled by means of the frequency f and the amplitude ΔI. In the example shown, the phase angle φ=0°. The other currents I of the electrodes 4b and 4c are offset by 120°, so that the phase angle of the current I of the electrode 4b is 120° and that of the electrode 4c is 240°. By means of this phase shift, rotation of the molten bath 10 is also achieved so that the convection is further improved and thus the scrap parts 8 can be melted in a shorter time.

The method described above is technically simple to realize since it can be carried out with a conventional electric arc furnace without any modification of the equipment. Only the target values for the effective value of the current fed to an electrode must be varied by programming means according to the above pattern. For this purpose, suitable software for carrying out the method according to the invention is implemented in the control/regulating unit 14. On the basis of a corresponding target value stipulation, the actual value of the current I is controlled/regulated to the pre-determined value by the control/regulating unit 14.

Although the invention has been illustrated and described in detail based on the preferred exemplary embodiment, the invention is not restricted by the examples given and other variations can be derived therefrom by a person skilled in the art without departing from the protective scope of the invention.

1. A method for operating an electric arc furnace comprising a furnace vessel for metal to be melted and having at least one electrode for generating an electric arc extending into the vessel;
an electric current supply to each of the electrodes, which supply is variable over time by at least one of variations of electric current and variations of frequency; and
the method comprising oscillating of a target value of current fed to the electrode about a pre-determined base value (I₀).

2. The method as claimed in claim 1, wherein the oscillation of the target value of the current takes place at a periodic frequency.

3. The method as claimed in claim 2, wherein the periodic frequency (f) is 0.2 Hz to 2 Hz.

4. The method as claimed in claim 1, further comprising causing the oscillation of the current (I) about the base value (I₀) by changing the amplitude and/or the periodic frequency (f) of the current (I).

5. The method as claimed in claim 4, further comprising increasing the periodic frequency (f) during a time segment.

6. The method as claimed in claim 4, wherein the electric arc furnace comprises three of the electrodes, each of the electrodes having a respective electric current supply for supplying a respective electric current to each of the three electrodes, and oscillating the three currents at a phase shift of 120°.

7. The method according to claim 6, wherein due to the oscillation of the target value of the current (I) at one after another at each of the three electrodes, generating a longer electric arc specifically at the respective electrode affected by the oscillation, and at the unaffected electrodes, generating an electric arc that is shorter relative to the longer electric arc.

8. The method as claimed in claim 6, arranging the three electrodes, seen in the direction of their longitudinal axes, on a circle, and circulating the longer electric arc in the electric arc furnace recurrently around a region enclosed by the circle.

9. The method as claimed in claim 1, wherein when scrap metal is present in the electric arc furnace vessel, by oscillating the target value of the current (I), increasing a radiation output power generated by the electric arcs in a targeted manner.

10. The method as claimed in claim 1, wherein when a molten bath is present in the electric arc furnace vessel, by oscillating the target value of the current (I) creating a movement of the molten bath in the electric arc furnace vessel.

11. The method as claimed in claim 10, further comprising creating a movement of the molten bath circulating around the at least one electrode, seen in the direction of its longitudinal axis, in a targeted manner.

12. An electric arc furnace having at least one electrode in a furnace vessel, an electric current supply to each of the at least one electrodes for creating an electric arc at each electrode, and
a control/regulating unit to each electrode for oscillating the electric current and for adjusting the frequency of the oscillation for each electrode about a predetermined base value.

13. The method as claimed in claim 1, wherein the oscillating target value of the current to the electrode is sufficient to cause each of the electrodes to generate an oscillating electric arc sufficient to cause movement of melted metal in the container.

14. The method as claimed in claim 1, wherein the oscillation causes a respective length of an arc from each electrode to oscillate.

15. The method as claimed in claim 14, wherein as the oscillation causes the length of the arc from one of the electrodes to increase, it causes the length of the arc from another of the electrodes to decrease.

16. The method as claimed in claim 4, wherein the electric arc furnace comprises a plurality of the electrodes, each of the electrodes having a respective electric current supply for supplying a respective electric current to each of the plurality of electrodes and oscillating the respective electric currents at a respective phase shaft with respect to the other electric currents.

17. The method according to claim 16, wherein due to the oscillation of the target value of the current (I) at one after another of each of the plurality of electrodes, generating a longer electric arc specifically at the respective electrode affected by the oscillation, and at the unaffected electrodes, generating an electric arc that is shorter relative to the longer electric arc.
